(19) United States
(12) Patent Application Publication
(10) Pub. No.: US 2005/0242256 A1
(43) Pub. Date: Nov. 3, 2005

(54) Glove box hook apparatus

(76) Inventor: Robert S. Evans, Lewes, DE (US)

Correspondence Address: S. Michael Bender, P.O. Box 530-399, St. Petersburg, FL, 33747, US

(21) Appl. No.: 11/117,997

(22) Filed: Apr. 29, 2005

Related U.S. Application Data
(60) Provisional application No. 60/566,985, filed on May 3, 2004.

(51) Int. Cl. F16B 45/00

(52) U.S. Cl. 248/307

(57) ABSTRACT

A glove box hook apparatus is provided for attachment to a glove box door which closes against a dashboard in a vehicle above the floor of the vehicle. The glove box hook apparatus includes a stop member, a flexible suspension member connected to the stop member, and a hook assembly connected to the flexible suspension member. When a bag is hung on the hook assembly, the bottom of the bag can rest on the floor of the vehicle, but, with the handles of the bag being hung from the hook assembly, the bag is prevented from falling over and the contents therein are prevented from spilling out of the bag. In general, the stop member has a relatively large thickness. The flexible suspension member has a relatively small thickness, and the stop-member thickness is large enough to prevent the stop member from moving through a clearance between the closed glove box door and the dashboard.

### CROSS-REFERENCE TO RELATED APPLICATION

This application claims priority based upon my copending Provisional Application Ser. No. 60/566,985; filed May 3, 2004.

### BACKGROUND OF THE INVENTION

1. Field of the Invention

The present invention relates generally to devices for suspending bags in a motor vehicle, and, more particularly, to device especially adapted for suspending a bag from a glove box door.

2. Description of the Prior Art

It is well known in a motor vehicle that trash can accumulate. In this respect, throughout the years, a number of innovations have been developed relating to supporting trash bags inside the motor vehicle so that accumulated trash can be retained in a neat and organized manner; and the following U.S. patents are representative of some of those innovations: U.S. Pat. Nos. 2,884,174, 5,246,190, 5,639,051, 5,769,294, and 5,975,594. More specifically, U.S. Pat. No. 2,884,174 discloses a trash bag holder that is attached to a glove box using a screw clamp. To install such a trash bag holder, the screw clamp must be screwed on. To remove such a trash bag holder, the screw clamp must be unscrewed. In order to provide simplicity and convenience in supporting a trash bag holder in a motor vehicle, it would be desirable if there was no need to employ a screw clamp for installing and removing the trash bag holder.

U.S. Pat. No. 5,246,190 discloses a trash bag clip for cars in which hooks for supporting a trash bag are supported on a substantially rigid hook support. In addition, the substantially rigid hook support is attached to a glove box door using long plastic tabs that are bent down to conform to the top and inside surfaces of the glove box door. Potentially, the lowermost ends of the long plastic tabs can snag onto items located near the floor of the glove box. To avoid such potential occurrences, it would be desirable if a glove-box-mounted support for a trash bag did not include long plastic mounting tabs that conform to the inside surface of the glove box door.

U.S. Pat. No. 5,639,051 discloses mounting plate for plastic bags, wherein the mounting plate is mounted by fasteners, such as screws, onto a vertical surface. If such a mounting plate were mounted on a glove box door, the screws would damage the glove box door. To avoid damaging a glove box door, it would be desirable if a glove-box-mounted support for a trash bag does not require screws that are screwed into the glove box door.

U.S. Pat. No. 5,769,294 discloses accessory hooks that are substantially permanently mounted in recesses in an interior wall of a motor vehicle. Sometimes trash bags are not employed inside a motor vehicle, and sometimes they are. In this respect, and for a variety of other reasons, it would be desirable to remove the mounting hooks for supporting a trash bag from the motor vehicle. In this respect, the trash bag mounting hooks should not be permanently attached to the outside of the glove box door.

U.S. Pat. No. 5,975,594 discloses a glove box door latch assembly with a utility hook. The utility hook may be used for supporting a trash bag. However, the vertical distance of the bag-supporting hook from the floor of the motor vehicle cannot be adjusted. This lack of adjustability is a problem because different trash bags have different lengths. Therefore, any support for trash bags should be vertically adjustable to accommodate trash bags of different lengths.

Still other features would be desirable in a glove box hook apparatus. For example, when a hook for supporting a trash bag is no longer needed, it would be desirable to be able to rapidly and conveniently place the unneeded hook inside the glove box until needed again. In addition, when the hook is no longer needed, it would be desirable to be able to rapidly and conveniently place a flexible suspension member for the hook inside the glove box until needed again.

Thus, while the foregoing body of prior art indicates it to be well known to use a device for suspending a trash bag from a glove box door, the prior art described above does not teach or suggest a glove box hook apparatus which has the following combination of desirable features: (1) does not employ a screw clamp for installing and removing a trash bag holder; (2) provides a glove-box-mounted support for a trash bag which does not include long plastic mounting tabs that conform to the inside surface of the glove box door; (3) does not require screws that are screwed into the glove box door; (4) is not permanently attached to the outside of the glove box door; (5) is vertically adjustable to accommodate trash bags of different lengths; (6) permits rapid and convenient placement of an unneeded hook inside the glove box until needed; and (7) provides rapid and convenient placement of a flexible suspension member for the hook inside the glove box until needed. The foregoing desired characteristics are provided by the unique glove box hook apparatus of the present invention as will be made apparent from the following description thereof. Other advantages of the present invention over the prior art also will be rendered evident.

### SUMMARY OF THE INVENTION

When a prepared meal is ordered from a restaurant for the purpose of taking that meal home, the meal typically is packaged and bagged for transport home for the most part in an automobile. The bag with the packaged meal then is put on the seat or the floor of the vehicle where it is subject to toppling over and at least upsetting the meal and possibly doing damage to the automobile's interior fabric.

The present invention is based on the recognition that meals packaged and bagged for take away from a restaurant can be conveniently secured and suspended for transport. The present invention can also be used to secure other items contained in a bag that someone would not want overturned or the items therein spilled.

In view of the above and to accomplish the objectives of the present invention, a glove box hook apparatus is provided for attachment to a glove box door which closes against a dashboard in a vehicle above the floor of the vehicle. The glove box hook apparatus includes a stop member, a flexible suspension member connected to the stop member, and a hook assembly connected to the flexible suspension member. When a bag is hung on the hook portion, the bottom of the bag can rest on the floor of the vehicle, but, with the handles of the bag being hung from the hook portion, the bag is prevented from falling over and the contents therein are prevented from upsetting or spilling out of the bag. The bag can also be suspended above the floor of the vehicle.

In general, the stop member has a relatively large stop-member thickness. The flexible suspension member has a relatively small suspension-member thickness, and the stop-member thickness is large enough to prevent the stop member from moving through a clearance between the closed glove box door and the dashboard. Preferably, the flexible suspension member is a flexible strap.

With one embodiment, the hook assembly includes a strap adjustment portion which receives a portion of the flexible strap, and a hook portion is connected to the flexible strap.

With another embodiment, a reel assembly is connected to the flexible suspension member. The reel assembly is attached to an inside portion of the glove box door.

With yet another embodiment, the hook assembly includes a first clamping member. A clamp member support bracket supports the first clamping member. A pivot pin is supported by the clamp member support bracket. A second clamping member is supported by the pivot pin, and a hook portion is connected to the second clamping member.

To accomplish the objectives of the present invention, a glove box hook apparatus is provided for attachment to a glove box door which closes against a dashboard in a vehicle above the floor of the vehicle. The glove box hook apparatus includes a stop member, a flexible suspension member connected to the stop member, and a hook assembly connected to the flexible suspension member. When a bag is hung on the hook portion, the bottom of the bag can rest on the floor of the vehicle, but, with the handles of the bag being hung from the hook portion, the bag is prevented from falling over and the contents therein are prevented from upsetting or spilling out of the bag. The bag can also be suspended above the floor of the vehicle.

In general, the stop member has a relatively large stop-member thickness. The flexible suspension member has a relatively small suspension-member thickness, and the stop-member thickness is large enough to prevent the stop member from moving through a clearance between the closed glove box door and the dashboard. Preferably, the flexible suspension member is a flexible strap.

With one embodiment, the hook assembly includes a strap adjustment portion which receives a portion of the flexible strap, and a hook portion is connected to the flexible strap.

With another embodiment, a reel assembly is connected to the flexible suspension member. The reel assembly is attached to an inside portion of the glove box door.

With yet another embodiment, the hook assembly includes a first clamping member. A clamp member support bracket supports the first clamping member. A pivot pin is supported by the clamp member support bracket. A second clamping member is supported by the pivot pin, and a hook portion is connected to the second clamping member.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved glove box hook apparatus which has all of the advantages of the prior art and none of the disadvantages.

It is another object of the present invention to provide a new and improved glove box hook apparatus which may be easily and efficiently manufactured and marketed.

It is a further object of the present invention to provide a new and improved glove box hook apparatus which is of durable and reliable construction.

An even further object of the present invention is to provide a new and improved glove box hook apparatus which is susceptible of a low cost of manufacture with regard to both materials and labor, and which accordingly is then susceptible of low prices of sale to the consuming public, thereby making such glove box hook apparatus available to the buying public.

Still yet a further object of the present invention is to provide a new and improved glove box hook apparatus which does not employ a screw clamp for installing and removing a trash bag holder.

Still another object of the present invention is to provide a new and improved glove box hook apparatus that provides a glove-box-mounted support for a trash bag which does not include long plastic mounting tabs that conform to the inside surface of the glove box door.

Yet another object of the present invention is to provide a new and improved glove box hook apparatus which does not require screws that are screwed into the glove box door.

Even another object of the present invention is to provide a new and improved glove box hook apparatus that is not permanently attached to the outside of the glove box door.

Still a further object of the present invention is to provide a new and improved glove box hook apparatus which is vertically adjustable to accommodate trash bags of different lengths.

Yet another object of the present invention is to provide a new and improved glove box hook apparatus that permits rapid and convenient placement of an unneeded hook inside the glove box until needed.

Still another object of the present invention is to provide a new and improved glove box hook apparatus which provides rapid and convenient placement of a flexible suspension member for the hook inside the glove box until needed.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the glove box hook apparatus of the invention install on a glove box door.

FIG. 2 is an enlarged front view of the portion of the embodiment of the invention contained in circled region 2 of FIG. 1.

FIG. 3 is a side view of the embodiment of the glove box hook apparatus of FIG. 2 taken along line 3-3 thereof.

FIG. 4 is an enlarged top view of the embodiment of the invention shown in FIG. 3 taken along line 4-4 thereof.

FIG. 5 is a side view of a second embodiment of the invention installed on a glove box door.

FIG. 6 is a side view of the embodiment of the invention shown in FIG. 5, wherein the glove box door is in an open condition.

FIG. 7 is a side view another embodiment of a locking mechanism for a hook of the invention, wherein the hook is in an unlocked condition.

FIG. 8 is a side view of the embodiment of the invention shown in FIG. 7, wherein the hook is in a locked condition.

### DESCRIPTION OF THE PREFERRED EMBODIMENT

With reference to the drawings, a new and improved glove box hook apparatus embodying the principles and concepts of the present invention will be described.

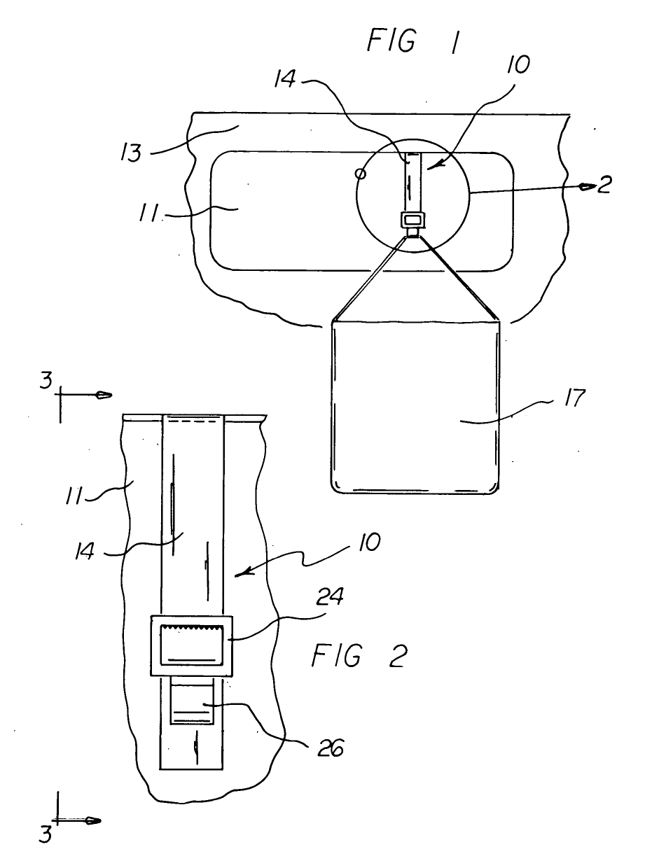

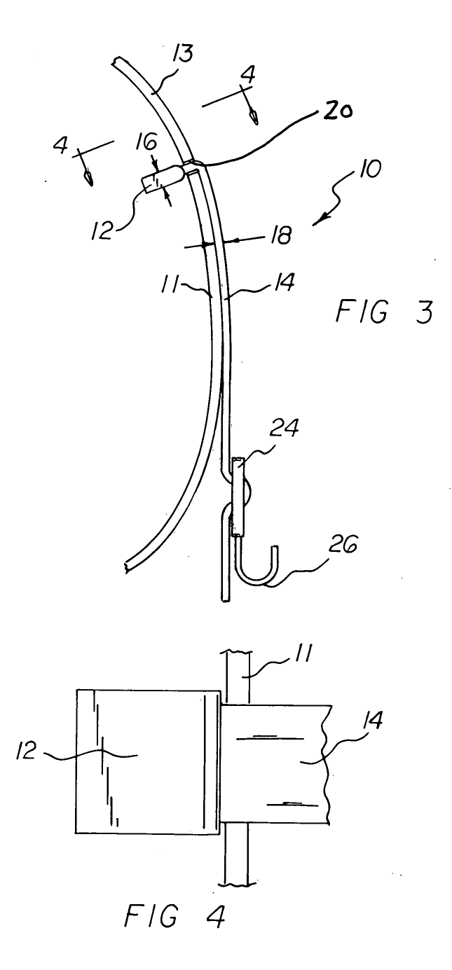

Turning to FIGS. 1-4, there is shown a first embodiment of the glove box hook apparatus of the invention generally designated by reference numeral 10. In the first embodiment, the glove box hook apparatus 10 is provided for attachment to a glove box door 11 which closes against a dashboard 13 in a vehicle above the floor of the vehicle. The glove box hook apparatus 10 includes a stop member 12, a flexible suspension member 14 connected to the stop member 12, and a hook assembly connected to the flexible suspension member 14.

In the embodiment of the invention shown in FIGS. 1-4, the stop member 12 has a relatively large stop-member thickness 16. The flexible suspension member 14 has a relatively small suspension-member thickness 18, and the stop-member thickness 16 is large enough to prevent the stop member 12 from moving through a clearance between the closed glove box door 11 and the dashboard 13. Preferably, the flexible suspension member 14 is a flexible strap 14.

The hook assembly includes a strap adjustment portion 24 which receives a portion of the flexible strap 14, and a hook portion 26 is connected to the flexible strap 14.

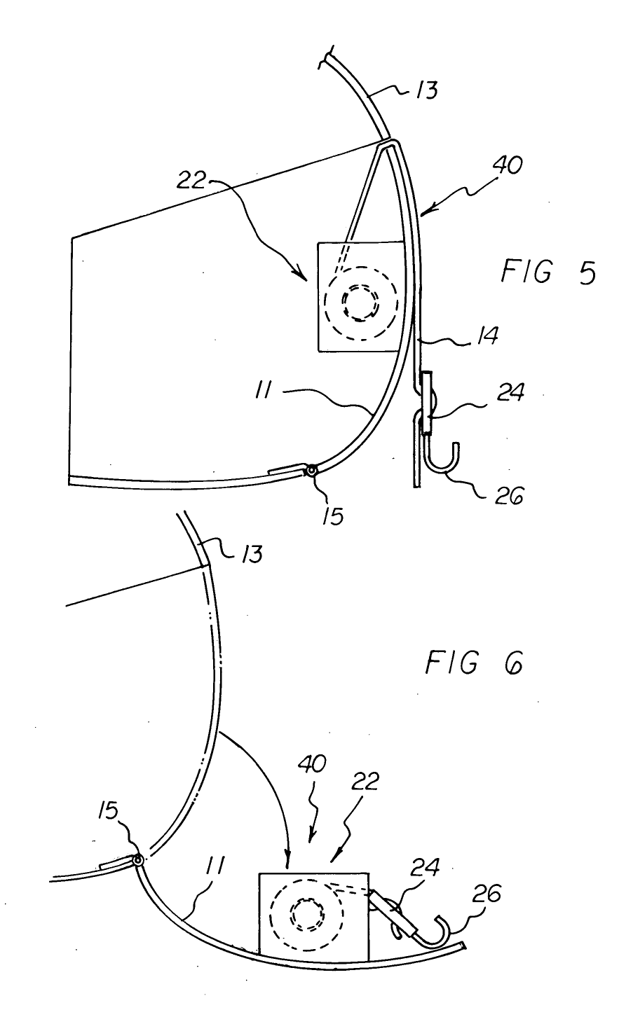

To operate the first embodiment of the invention, the glove box door 11 is opened. That is, the glove box door 11 is swung open around hinge 15, as shown in FIGS. 5-6. With the glove box door 11 in the open condition, the distal end of the flexible suspension member 14 is placed inside the glove box so that the stop member 12 is inside the glove box. Then, the glove box door 11 is closed. When this is done, the stop member 12 is trapped inside the glove box, and the distal end of the is threaded through the clearance 20 between the dashboard 13 and the glove box door 11. This is so because the stop member 12 has the stop-member thickness 16 which is greater than the clearance 20 between the dashboard 13 and the glove box door 11, in addition, because the clearance 20 is greater than the suspension-member thickness 18.

The distance between the hook portion 26 and the top of the glove box door 11 is adjusted by adjusting the strap adjustment portion 24 along the flexible suspension member 14. Also, the position of the hook portion 26 along the flexible suspension member 14 is adjusted in order to accommodate a bag 17 to be hung from the hook portion 26. When the bag 17 is hung on the hook portion 26, the bottom of the bag 17 can rest on the floor of the vehicle, and with the handles of the bag 17 being hung from the hook portion 26, the bag 17 is prevented from falling over and the contents therein are preventing from spilling out onto the floor of the vehicle.

When the glove box hook apparatus 10 of the invention is not needed for supporting an object, such as the bag 17, from the hook portion 26, then the glove box door 11 is opened, and the glove box hook apparatus 10 can be placed inside the glove box for storage.

In the second embodiment 40 of the invention shown in FIGS. 5-6, a reel assembly 22 is connected to the flexible suspension member 14. The reel assembly 22 is attached to an inside portion of the glove box door 11.

With employment of the reel assembly 22, the stop member 12 is attached to the reel assembly 22, which, in turn, is attached to the glove box door 11. Even when the flexible suspension member 14 is fully unreeled from the reel assembly 22, as shown in FIG. 5, the position of the hook portion 26 between the top of the glove box door 11 and the floor of the vehicle can be adjusted by movement of the strap adjustment portion 24 along the flexible suspension member 14.

When the glove box hook apparatus 10 is not needed for using the hook portion 26 to support an object, such as a bag 17, the flexible suspension member 14 can be reeled back up into the reel assembly 22 so that the hook portion 26 will be housed inside the glove box. This reeled-up condition is shown in FIG. 6.

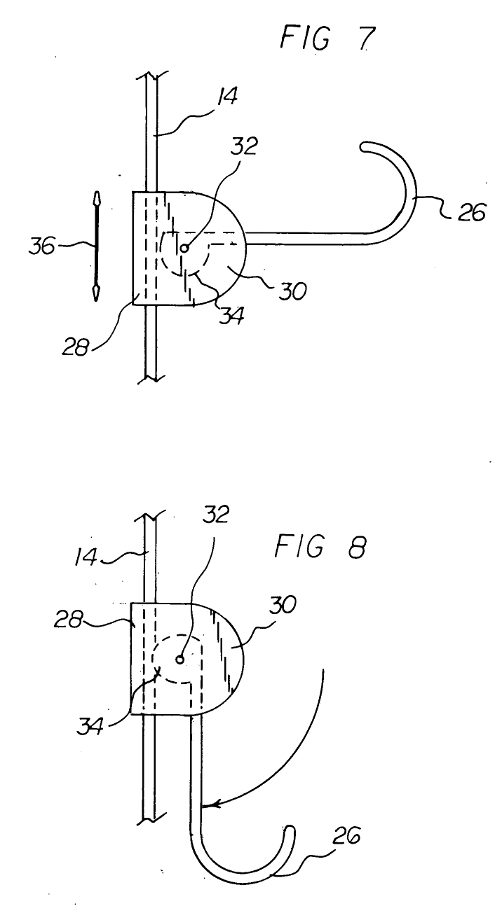

In the embodiment of the invention shown in FIGS. 7-8, the hook assembly includes a first clamping member 28. A clamp member support bracket 30 supports the first clamping member 28. A pivot pin 32 is supported by the clamp member support bracket 30. A second clamping member 34 is supported by the pivot pin 32, and a hook portion 26 is connected to the second clamping member 34.

The embodiment of the invention shown in FIGS. 7-8 provides an alternative to the strap adjustment portion 24 provided in other embodiments. More specifically, the hook portion 26 is moved to the position shown in FIG. 7, whereby the straight shaft of the hook portion 26 is perpendicular to the flexible suspension member 14. In this orientation of the hook portion 26, the second clamping member 34 is not in clamping contact with the flexible suspension member 14. In this condition, the clamp member support bracket 30 can be moved upward or downward along the flexible suspension member 14 as indicated by double-headed directional arrow 36 in FIG. 7.

Once a desired position of the hook portion 26 along the flexible suspension member 14 is reached, the hook portion 26 is rotated around the pivot pin 32, as shown by directional arrow 38 in FIG. 8, so that the second clamping member 34 comes into clamping contact with the flexible suspension member 14. That is, the second clamping member 34 clamps and locks the flexible suspension member 14 between the second clamping member 34 and the first clamping member 28. This clamping action fixes the position of the hook portion 26 along the flexible suspension member 14.

To change the position of the hook portion 26 along the flexible suspension member 14, these steps are first reversed and then repeated.

The components of the glove box hook apparatus of the invention can be made from inexpensive and durable metal, cloth, and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved glove box hook apparatus that is low in cost, relatively simple in design and operation, and which does not employ a screw clamp for installing and removing a trash bag holder. With the invention, a glove box hook apparatus provides a glove-box-mounted support for a trash bag which does not include long plastic mounting tabs that conform to the inside surface of the glove box door. With the invention, a glove box hook apparatus is provided which does not require screws that are screwed into the glove box door. With the invention, a glove box hook apparatus is provided which is not permanently attached to the outside of the glove box door. With the invention, a glove box hook apparatus is provided which is vertically adjustable to accommodate trash bags of different lengths. With the invention, a glove box hook apparatus is provided which permits rapid and convenient placement of an unneeded hook inside the glove box until needed. With the invention, a glove box hook apparatus provides rapid and convenient placement of a flexible suspension member for the hook inside the glove box until needed.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A glove box hook apparatus for attachment to a glove box door which closes against a dashboard, comprising:
a stop member,
a flexible suspension member connected to said stop member, and
a hook assembly adjustably connected to said flexible suspension member.

2. The apparatus of claim 1 wherein:
said stop member has a relatively large stop-member thickness,
said flexible suspension member has a relatively small suspension-member thickness, and
said stop-member thickness is large enough to prevent said stop member from moving through a clearance between the closed glove box door and the dashboard.

3. The apparatus of claim 1 wherein said flexible suspension member is a flexible strap.

4. The apparatus of claim 3 wherein said hook assembly includes:
a strap adjustment portion receiving a portion of said flexible strap, and
a hook portion connected to said flexible strap.

5. The apparatus of claim 1, further including:
a reel assembly connected to said suspension member, wherein said reel assembly is attached to an inside portion of the glove box door.

6. The apparatus of claim 1 wherein said hook assembly includes:
a first clamping member,
a clamp member support bracket which supports said first clamping member,
a pivot pin supported by said clamp member support bracket,
a second clamping member supported by said pivot pin, and
a hook portion connected to said second clamping member.
